(19) United States
(12) Patent Application Publication
(10) Pub. No.: US 2010/0055437 A1
(43) Pub. Date: Mar. 4, 2010

(54) ANTI-MICROBIAL FIBERS AND RELATED ARTICLES AND METHODS

(75) Inventors: E. David Fink, Franklin, MA (US); Ronald F. Vitaris, Worcester, MA (US); Chirag B. Shah, North Attleboro, MA (US); Sharon A. Mulligan, Bristol, RI (US); Brian Dowd, Dedham, MA (US); Scott Orr, Franklin, MA (US)

Correspondence Address: TYCO HEALTHCARE GROUP LP, 15 HAMPSHIRE STREET, MANSFIELD, MA, 02048, US

(73) Assignee: Tyco Healthcare Group LP, Mansfield, MA (US)

(21) Appl. No.: 12/548,494

(22) Filed: Aug. 27, 2009

Related U.S. Application Data
(60) Provisional application No. 61/136,322, filed on Aug. 28, 2008.

(51) Int. Cl. D02G 3/36; D02G 3/00; B32B 5/02; B32B 3/26

(52) U.S. Cl. 428/221; 428/375; 428/379; 428/393; 428/394; 428/395

(57) ABSTRACT

An antimicrobial fiber is described including: an inner layer and an outer layer; wherein the inner layer and the outer layer comprise at least one of the following characteristics: (I) the inner layer and the outer layer comprise of different concentrations, or different release rates, of at least one antimicrobial agent; and (II) the inner layer and the outer layer comprise different antimicrobial agents. An alternative antimicrobial fiber includes an antimicrobial agent compounded or combined with a dissolvable substance to promote release or binding of the antimicrobial agent. Related articles are also described.

### FIELD

The present invention is directed to anti-microbial fibers, articles comprising said fibers, and related methods.

### BACKGROUND

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

A variety of anti-microbial compositions, articles and methods have been suggested. However, such compositions, articles and methods possess various deficiencies and shortcomings in terms of antimicrobial efficacy.

A need still exists in the art for compositions, articles and methods which have, for example, increased effectiveness in reducing and/or preventing development of unwanted microbial organisms, are safe, and provide for improved efficiencies and reduced costs in wound care management.

While certain aspects of conventional technologies have been discussed to facilitate disclosure of the invention, Applicants in no way disclaim these technical aspects, and it is contemplated that the claimed invention may encompass one or more of the conventional technical aspects discussed herein

### DEFINITIONS

As used herein, unless otherwise indicated, the terms “microbial organism” or “microbial” will be used to refer to microscopic organisms of matter, including fungal, bacterial and/or viral organisms. Thus, the term “antimicrobial” as used herein refers to a composition or agent that kills or otherwise inhibits the growth of such fungal, bacterial and/or viral organisms.

### SUMMARY

The present invention may address one or more of the problems and deficiencies of the prior art discussed above. However, it is contemplated that the invention may prove useful in addressing other problems and deficiencies, or provide benefits and advantages, in a number of technical areas. Therefore the claimed invention should not necessarily be construed as limited to addressing any of the particular problems or deficiencies discussed herein.

The present invention may optionally possess one or more of the following benefits or advantages: (i) regulation of the efficacy of a single or combination of antimicrobial agents for a more synergistic effect in, for example, a wound dressing; (ii) use of multiple antimicrobial agents in a single dressing to provide longer wear times and increased microbial log reductions.

The present invention may also optionally possess one or more of the following features, benefits and/or advantages: (i) an antimicrobial dressing wherein the amount and release profile of the antimicrobial can be adjusted based on a specific application/need; (ii) a programmable or adjustable antimicrobial dressing that allows the clinician to select the appropriate treatment strength of characteristics depending on wound or environmental or microbial conditions.

According to one aspect, the present invention provides an antimicrobial fiber comprising: an inner layer and an outer layer; wherein the inner layer and the outer layer comprises at least one of the following characteristics: (I) the inner layer and the outer layer comprise of different concentrations, or different release rates, of at least one antimicrobial agent; and (II) the inner layer and the outer layer comprise different antimicrobial agents.

According to a further aspect, the present invention provides an antimicrobial fiber comprising an antimicrobial agent compounded or combined with a dissolvable substance to promote release or binding of the antimicrobial agent.

According to another aspect, the present invention provides an article comprising a plurality of antimicrobial fibers, wherein the article comprises a fiber density gradient or porosity gradient, thereby providing the article with an antimicrobial concentration gradient.

According to an additional aspect, the present invention provides an article comprising a plurality of antimicrobial fibers, wherein the article comprises a homogenous blend of fibers of uniform fiber density, wherein a first portion of the fibers have a first antimicrobial concentration level or first antimicrobial elution rate, and wherein a second portion of the fibers have a second antimicrobial concentration or second antimicrobial elution rate.

### BRIEF DESCRIPTION OF THE DRAWINGS

FIG. 1 is a cross-sectional view of a fiber of the present invention.

FIG. 2 is a cross-sectional view of a fiber constructed according to an alternative embodiment of the present invention.

FIG. 3 is a cross-sectional view of a fiber constructed according to a further alternative embodiment of the present invention.

### DETAILED DESCRIPTION

According to the present invention, one or more fibers are treated with one or more anti-microbial agents. Any suitable antimicrobial agent(s) can be utilized for this purpose. Such agents include, but are not limited to one or more of: polymeric biguanides such as PHMB and PEHMB; metals such as silver, gold, zinc or copper; and quaternary ammonium compounds (e.g. chlorhexidine gluconate). Moreover, any suitable fiber may be utilized. Such fibers may be natural, synthetic, or semi-synthetic. Suitable materials from which fibers can be formed include, but are not limited to: cellulose, cellulose acetate, oxycellulose, alginates, cotton, polypropylene, polyvinyl alcohol, rayon, aramids, nylon, acrylic, polyester, PTFE, Kevlar, chitosan, polyurethane, PGA, collagen, poly(ethylene terephthate) (PET), hydrogels, hydrocolloids, degradable polymeric materials (e.g., PLA, PGA, PLGA, PLLA, PCL, and amino acid based polyester amide copolymers) and combinations thereof.

The type of fiber utilized can be chosen for, among other reasons, compatibility with a one or more particular antimicrobial agent(s). For example, cellulosic or rayon fibers are effectively bind PHMB in various concentrations. Certain fibers such as nylon or polyester can be compounded with a silver antimicrobial agent.

The antimicrobial agent can be combined with the fibers by any suitable technique. Thus, for example, the fibers can be coated with, or immersed within, a solution containing a suitable antimicrobial agent. Alternatively, the antimicrobial agent can be contained in a bulk material, such as a resin, from which the fibers may be formed. The combination of the base resin and antimicrobial agent can be programmed in concentration such that the antimicrobial efficacy is adjusted to the end product need.

According to one optional embodiment, the antimicrobial agent is associated with the fiber in powder form. The particle size of the powder can be varied thus providing a desired surface area, and thus a means to control the rate of release of the antimicrobial agent. An example of this action would be combining various particle sizes of antimicrobial agent into a base fiber resin which can be hydrophilic. The material is then spun into a fiber where the antimicrobial becomes active when in contact with moisture. The varied particle sizes and resulting surface areas will provide a dynamic availability if antimicrobial. Large particles will supply antimicrobial over a longer period of time where small particles can provide a more rapid release of antimicrobial

In a further alternative embodiment, the antimicrobial agent may be compounded or combined with a dissolvable substance, such that dissolution of the dissolvable substance acts to promote release of the antimicrobial agent. Thus, the release rate (or lack thereof) of the antimicrobial agent can be programmed or adjusted by selection of the dissolvable substance, and the rate of dissolution thereof. Any suitable to dissolvable substance can be utilized for this purpose. Non-limiting examples include: hydrogel, starch film (or powder); and phosphate glass. An illustrative example of this action would be the use of phosphate glass particles containing ionic silver. The phosphate glass dissolves in contact with moisture and that dissolution rate can be adjusted by varying the constituents of the phosphate glass. Further, the amount of ionic silver mixed with the glass can be varied to provide higher concentrations of antimicrobial as desired. The result of these varied combinations of dissolvable glass and ionic silver can be a programmed release of silver from the fiber that may include a large initial release followed by a slower release over a long period of time. The end application can dictate the optimal use of the combination technology. Other examples may include the use of hydrogels with a similar dynamic effect as the phosphate glass. Hydrogels of differing absorption characteristics can be utilized in combination with varying degrees of antimicrobials to provide desired efficacy when attached or bound to fibers.

A chelating agent, such as EDTA, can optionally be added to the fiber(s) to enhance the antimicrobial efficacy of all the agents. The chelating agent can be combined with the fibers and/or other agents by any suitable manner, as previously discussed above. Thus, for example, the chelating agent can be associated with a suitable dissolvable substance of the type described above to provide a desired release or binding mechanism therefor.

The antimicrobial fibers of the present invention may optionally be provided with hydrophilic or hydrophobic properties. These properties can be provided by forming the fibers from hydrophilic or hydrophobic materials, or by treating the base material of the fiber so as to provide a hydrophilic or hydrophobic behavior thereto. An example of a hydrophilic property in a fiber may be the use of a hydrophilic resin such as but not limited to nylon that absorbs moisture on fluid contact. The nylon fiber base resin may be combined with a hydrophilic antimicrobial technology such as phosphate glass with ionic silver to achieve a desired antimicrobial affect when spun in a fiber form. Conversely, a hydrophobic material such as polypropylene can be spun in fiber form and coated or treated with an antimicrobial agent such as PHMB such that the PHMB is totally available as an antimicrobial for quick action. It can be envisioned that combining these two hydrophobic and hydrophilic fibers would achieve synergistic antimicrobial efficacy in a wide ranging number of applications.

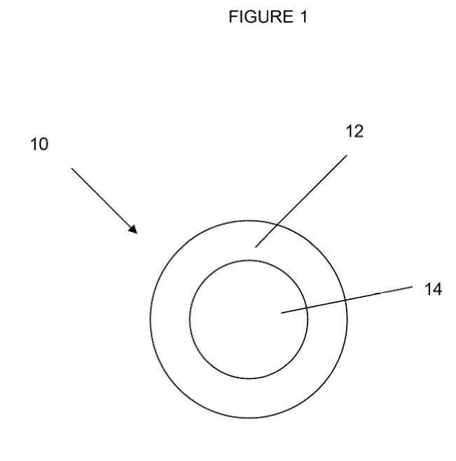

As illustrated in FIG. 1, a fiber 10 formed according to certain aspects of the present invention can be a bi-component or co-extruded construct such that an outer layer (sheath) 12 is formed over an inner layer or core 14. Such a construction provides a number of different possibilities. For example, the outer layer or sheet 12 may contain a very high level of antimicrobial agent (e.g., up to 70% by weight) and the inner core 14 may contain a lower percentage of antimicrobial agent (e.g., less than 20% by weight) to maintain fiber integrity. Any suitable antimicrobial agent can be utilized, as previously described above. Moreover, according to further alternative embodiments, the outer layer 12 and inner layer 14 may contain different antimicrobial and/or chelating agents. For example the outer layer may contain a high concentration of quick releasing antimicrobial agent as described above where the inner layer may be a slower releasing profile to provide longer term efficacy. It is also envisioned that the fiber materials can also be varied such that the inner core may be spun from a hydrophilic nylon and the outer core spun from a less hydrophilic polyester. Again, the addition of varying levels of antimicrobials can also enhance the efficacy of the fiber combination's performance.

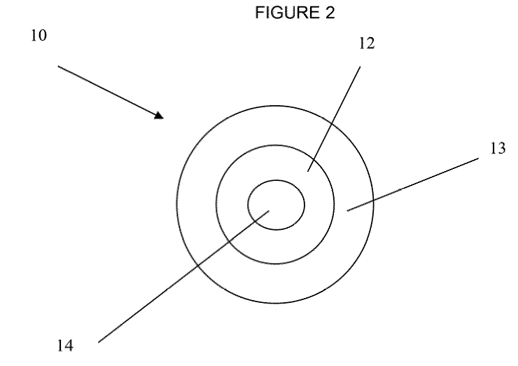

As further illustrated in FIG. 2, according to a further embodiment, the fiber 10 can be provided with multiple layers or sheaths formed over a core or inner layer. Thus, for example, one or more additional layers or sheaths 13 may be provided. As discussed above, the core or inner layer 14 and the plurality of additional layers or sheaths 12, 13 can contain different concentrations of a common antimicrobial agent and/or contain different antimicrobial agents.

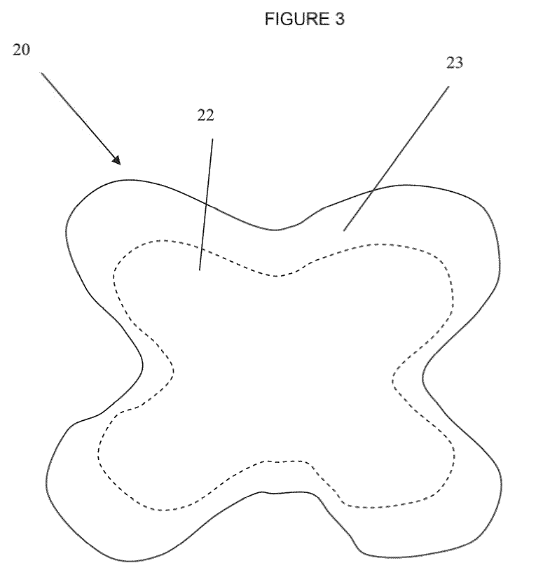

Fibers formed according to the present invention are not limited to the cross-sectional geometrical configurations illustrated in FIGS. 1 and 2. The fibers of the present invention can assume any suitable geometrical configuration. Thus, as illustrated in FIG. 3, a fiber 20 of the present invention may possess a quad shape, or one with grooves, to further increase fiber surface area to wound fluid contact. The fiber 20 may further contain more two layers 22, 23 over a central core 24, each with each layer programmed to function in a prescribed manner of antimicrobial release or fiber integrity. Thus, for example, the core 24 and the plurality of additional layers or sheaths 22, 23 can contain different concentrations of a common antimicrobial agent and/or contain different antimicrobial agents.

A number of different articles and wound treatment methods can be formed from, or practiced with, the above-described fibers. Such articles and methods are also comprehended by the present invention

Thus, an article such as a wound dressing can be formed from a combination of antimicrobially treated natural and synthetic fibers, and may be constructed as a homogeneous blend of the treated fibers. The percentage of treated synthetic fibers to treated natural fibers can be varied to suit the end use. Selected fibers could be absorbable or non-absorbable. The dressing can be provided with either a uniform fiber density or a density gradient such that higher concentrations of antimicrobial agent could be located adjacent to the wound surface.

According to further embodiments, the invention comprises an article such as a wound dressing with programmable antimicrobial release. A dressing can be made from different materials treated with a suitable antimicrobial agent such as polymeric biguanides (e.g., PHMB and/or PEHMB). The materials either have different concentrations or release different levels of the antimicrobial agent because of the fabric/material or construction. The antimicrobial agent concentrations could vary in different layers of the dressing such that one or more layers have a much higher concentration than others; an example may be a center layer with a high concentration of antimicorbial agent, such as PHMB, to more effectively control high levels of microbes that are associated with absorbed wound exudate (fluid). Treated fabrics can be manufactured from a variety of fibers such as those previously described herein. The fabrics can be in a variety of different configurations: woven, non-woven, knit, felt, or braided or in a mat form. The materials can provide a density gradient or controlled pore size to promote vertical or lateral wicking. There can be provided a range of platforms or layers with different release and/or bound antimicrobial profiles.

Also disclosed are fibrous articles such as wound dressings wherein the fibers are hydrophilic and treated with or contain an antimicrobial. Said fibrous wound dressing would contain a wide range of fiber denier either oriented in such a way to produce an increasing denier gradient or a uniform mixture. Smaller denier fibers create a larger amount of fiber surface area, thus they would more quickly release or contain the antimicrobial than larger denier fibers, assuming a constant elution and constant fiber blend. This feature would provide for a sustained release of an antimicrobial agent. The fibers could also be hydrophobic such that wound exudate would readily pass through the dressing construct, be treated with a selected antimicrobial agent (or combination thereof) and dispensed outside the wound dressing.

It is also envisioned that the various articles such as fibrous wound dressings can be formed from a blend of different fibers, having different deniers, different materials and different antimicrobials. For example, a dressing can contain a polymeric biguanide such as PHMB, combined in a number of possible ways with a metallic antimicrobial agent, such as silver. The antimicrobial effect of PHMB would be quicker, and the silver more prolonged. The level of silver added to the base fiber material could range between 0.5 and 40% by weight depending on the level of silver ionic elution desired in the product. The concentration of PHMB could vary from 500 ppm (0.05%) to 100,000 (10%) ppm by weight.

An article, such as a wound dressing according to the present invention can be composed of an assortment of bi-component fibers of the type described herein where the outer sheath contains an antimicrobial agent, is dissolvable, and the fibers that comprise the wound dressing have different dissolution rates. Similarly, the disclosed dressing can be comprised of an array of bi-component fibers where the inner core contains the antimicrobial which is released after the sheath dissolves. The level of antimicrobial agent can be varied in the different materials used in the bi-component complex such that an ideal or programmed released of the agent is present in each component. For example, the outer sheath of the fiber can be composed of a more hydrophilic polymer blended with the antimicrobial that would permit a more controlled release of the agent. The inner core can be a material with greater strength for better fiber integrity. The combination of fibers can be adjusted such that a programmed efficacy of the various antimicrobial agents is gained. For example, one agent may be active in a beginning phase with another agent becoming active subsequently for a longer period of time.

Articles such as wound dressings can, of course, include additional active ingredients or agents such as, for example, a therapeutic agent, an organoleptic agent, a growth factor, an analgesic, a tissue scaffolding agent, a haemostatic agent, a protein inhibitor, collagen, enzymes, an anti-thrombogenic agent, an anesthetic, an anti-inflammatory agent, an anticancer agent, a vasodilation substance, a wound healing agent, an angiogenic agent, an angiostatic agent, an immune boosting agent, a skin sealing agent, an agent to induce directional bacterial growth, an agent to impart bactericidal or bacteriostatic activity, an electron transfer agent to destabilize or destroy the metabolic action of microbes and/or biofilm formation, combinations thereof and the like. Release of active agents may be triggered by a variety of means, such as, for example, an electric field or signal, temperature, time, pressure, moisture, light (e.g., ultra-violet light), ultrasound energy, sonication, combinations thereof and the like.

Any numbers expressing quantities of ingredients, constituents, reaction conditions, and so forth used in the specification are to be understood as being modified in all instances by the term “about”. Notwithstanding that the numerical ranges and parameters setting forth, the broad scope of the subject matter presented herein are approximations, the numerical values set forth are indicated as precisely as possible. Any numerical value, however, may inherently contain certain errors as evident from the standard deviation found in their respective measurement techniques. None of the features recited herein should be interpreted as invoking 35 U.S.C. §112, ¶6, unless the term “means” is explicitly used.

Although the present invention has been described in connection with preferred embodiments thereof, it will be appreciated by those skilled in the art that additions, deletions, modifications, and substitutions not specifically described may be made without departing from the spirit and scope of the invention.

We claim:

1. An antimicrobial fiber comprising:
an inner layer and an outer layer;
wherein the inner layer and the outer layer comprises at least one of the following characteristics;
(I) the inner layer and the outer layer comprise different concentrations, or different release rates, of at least one antimicrobial agent; and
(II) the inner layer and the outer layer comprise different antimicrobial agents.

2. The fiber of claim 1, wherein the antimicrobial agent comprises one or more of a polymeric biguanide and a metal.

3. The fiber of claim 2, wherein the polymeric biguanide comprises PHMB and the metal comprises silver.

4. The fiber of claim 1, wherein the fiber comprises: cellulose, cellulose acetate, oxycellulose, alginates, cotton, polypropylene, polyvinyl alcohol, rayon, aramids, nylon, acrylic, polyester, PTFE, Kevlar, chitosan, polyurethane, PGA, collagen, poly(ethylene terephthate) (PET), hydrogels, hydrocolloids, PLA, PGA, PLGA, PLLA, PCL, or amino acid based polyester amide copolymers; and combinations thereof.

5. The fiber of claim 1, wherein the antimicrobial agent is in powder form.

6. The fiber of claim 1, wherein the antimicrobial agent is compounded or combined with a dissolvable substance to promote release or binding of the antimicrobial agent.

7. The fiber of claim 6, wherein the dissolvable substance comprises: hydrogel; starch film; starch powder; phosphate glass; or combinations thereof.

8. The fiber of claim 1, further comprising a chelating agent.

9. The fiber of claim 8, further comprising a dissolvable substance associated with the least one of the antimicrobial agent and the cleaning agent.

10. The fiber of claim 1, wherein the fiber comprises at least one of hydrophilic and hydrophobic properties.

11. The fiber of claim 1, wherein the inner layer comprises a lower concentration of antimicrobial agent than the outer layer.

12. The fiber of claim 1, further comprising at least one additional layer.

13. The fiber of claim 12, wherein the at least one additional layer comprises at least one of:
(I) different concentrations, or different release rates, of an antimicrobial agent relative to at least one of the inner and outer layer; and
(II) a different antimicrobial agent relative to at least one of the inner and outer layer.

14. The fiber of claim 1, comprising a substantially round or substantially quad-shaped cross-sectional geometry.

15. An article comprising a plurality of fibers, wherein at least some of the fibers are constructed according to the fiber of claim 1.

16. An antimicrobial fiber comprising an antimicrobial agent compounded or combined with a dissolvable substance to promote release or binding of the antimicrobial agent.

17. The fiber of claim 16, wherein the dissolvable substance comprises: hydrogel; starch film; starch powder; phosphate glass; or combinations thereof.

18. The fiber of claim 16, further comprising a chelating agent.

19. The fiber of claim 16, wherein the fiber comprises at least one of hydrophilic and hydrophobic properties.

20. The fiber of claim 16, comprising a substantially round or substantially quad-shaped cross-sectional geometry.

21. The fiber of claim 16, further comprising a mechanism for sensing abnormal levels of microbes in triggering activation of the at least one antimicrobial agent.

22. An article comprising a plurality of antimicrobial fibers, wherein the article comprises a fiber density gradient or porosity gradient, thereby providing the article with an antimicrobial concentration gradient.

23. The article claim 22, wherein the article is constructed such that a higher concentration of antimicrobial agent is located adjacent to a surface of the article to be applied to a wound.

24. The article of claim 22, wherein the article is formed from antimicrobial fibers comprising at least one of: different fiber denier; different base fiber materials; different antimicrobial agents; or different antimicrobial elution-rates.

25. The fiber of claim 22, further comprising a mechanism for sensing abnormal levels of microbes in triggering activation of the at least one antimicrobial agent.

26. An article comprising a plurality of antimicrobial fibers, wherein the article comprises a homogenous blend of fibers of uniform fiber density, wherein a first portion of the fibers have a first antimicrobial concentration level or first antimicrobial elution rate, and wherein a second portion of the fibers have a second antimicrobial concentration or second antimicrobial elution rate.

27. The article of claim 26, wherein the article is constructed such that a higher concentration of antimicrobial agent is located adjacent to a surface of the article to be applied to a wound.
